(19) United States
(12) Patent Application Publication
(10) Pub. No.: US 2022/0129978 A1
(43) Pub. Date: Apr. 28, 2022

(54) SYSTEM AND METHOD FOR IMPLEMENTING A REAL TIME CREDIT LIMIT INCREASE PROCESS

(71) Applicant: JPMorgan Chase Bank, N.A., New York, NY (US)

(72) Inventor: Dipak THAKARE, Hyderabad (IN)

(73) Assignee: JPMorgan Chase Bank, N.A., New York, NY (US)

(21) Appl. No.: 17/451,371

(22) Filed: Oct. 19, 2021

Related U.S. Application Data
(60) Provisional application No. 63/122,305, filed on Dec. 7, 2020.

(30) Foreign Application Priority Data
Oct. 22, 2020 (IN) 202011046142

(51) Int. Cl. G06Q 40/02; G06Q 20/40; G06Q 20/20; G06Q 20/10

(52) U.S. Cl. CPC G06Q 40/025; G06Q 20/405; G06Q 20/4016; G06Q 20/108; G06Q 20/202

(57) ABSTRACT

A system and method for implementing a real time credit limit increase process are disclosed. A processor causes a card servicing computing device to receive transaction data originated at a point of sale terminal device when a card user initiates a card transaction. The processor accesses a file from a database in real time to check whether the card user is among the card users who are eligible for a credit limit increase based on the received transaction data; determines whether the transaction data is equal to or above a predetermined threshold data; and transmits an electronic notification to a card user computing device in real time based on a positive determination that the transaction data is equal to or above a predetermined threshold data along with a link to a digital channel where the client can opt in for increase in credit limit.

### CROSS-REFERENCE TO RELATED APPLICATIONS

This application claims the benefit of priority from U.S. Provisional Patent Application No. 63/122,305, filed Dec. 7, 2020, which is herein incorporated by reference in its entirety. This application also claims the benefit of priority from Indian Provisional Patent Application No. 202011046142, filed Oct. 22, 2020, which is herein incorporated by reference in its entirety.

### TECHNICAL FIELD

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

This disclosure generally relates to data processing, and, more particularly, to methods and apparatuses for implementing a credit limit increase module that sends a notification in real time to a client computing device as soon as a threshold credit limit is detected based received transaction data along with a link to a digital channel where the client can opt in for increase in credit limit.

### BACKGROUND

In today's existing credit limit upgrade process, it may take over thirty days to send notifications to customers informing them of their eligibility for upgrading. When these eligible customers reaches a certain threshold of their available credit limit, there appears to be no mechanism to alert the customer in real time if they wish to increase their available credit limit. Since a bank takes more time in sending notification after determining eligibility, typically only 5% of responses out of 1.2 million approximate eligible customers.

For example, from the customer base of 45 million for J.P. Morgan and Chase (JPMC), which holds about 60 million accounts, all may not be eligible for the credit limit increase. The eligible or pre-qualified customers may be identified based on the spending pattern, ability to pay and strategies applied to historical data. This processed data may be utilized to identify the list of customers eligible for credit limit increase. However, these eligible customers typically has to wait for over thirty days to complete an upgrade as lot of different teams (risk, analytics, origination application, card holder servicing application, etc.) working independently causing delays in customer getting notification that they are eligible for upgrade. This may lead to delay in actual application coming to bank which has potential to a lot of other business opportunities. This pre-qualified customers list would be typically operated in the following manner. The risk team may finalize the list of customers who are eligible for credit limit increase based on numerous rules. That file may be then sent to acquisition/origination team to load into production. Marketing team may then send out offers, that's when the customer applies for credit limit increase either online or through service. Those typical systems may connect to the file in acquisition/origination team to see if the offer from the risk file placed out there is still available. If the offer is still available, the customer can apply and then the end decision may be based on risk and policy engine rules for ability to pay, thereby approving or declining the credit limit increase request. Thus, the current marketing process may take over thirty days from deciding eligibility to sending notification and finally approving or declining the credit limit increase request.

### SUMMARY

The present disclosure, through one or more of its various aspects, embodiments, and/or specific features or sub-components, provides, among other features, various systems, servers, devices, methods, media, programs, and platforms for implementing a credit limit increase module that sends a notification in real time to a client computing device as soon as a threshold credit limit is detected based received transaction data along with a link to a digital channel where the client can opt in for increase in credit limit, but the disclosure is not limited thereto.

According to an aspect of the present disclosure, a method for implementing a credit limit increase process by utilizing one or more processors and one or more memories is disclosed. The method may include: causing a risk team computing device to access a database for receiving historical data associated with card user information; applying rules on the historical data; electronically generating a file that includes data corresponding to card users who are eligible for a credit limit increase based on the applied rules on the historical data; transmitting the file to a card servicing computing device; causing the card servicing computing device to validate that the card users are still eligible for the credit limit increase and maintain the file on the database based on validation; causing the card servicing computing device to receive transaction data originated at a point of sale terminal device when the card user initiates a card transaction; accessing the file from the database in real time to check whether the card user is among the card users who are eligible for a credit limit increase based on the received transaction data; determining whether the transaction data is equal to or above a predetermined threshold data; and transmitting an electronic notification to a card user computing device in real time to notify that the card user is eligible for the credit limit increase based on a positive determination that the transaction data is equal to or above a predetermined threshold data.

According to a further aspect of the present disclosure, wherein transmitting the electronic notification includes transmitting the electronic notification to the card user computing device in real time in accordance with any one of the group consisting of SMS (Short Message Service), IM (Instant Message), and e-mail, but the disclosure is not limited thereto.

According to another aspect of the present disclosure, the method may further include: receiving input data from the card user computing device to accept the credit limit increase; and automatically approving the credit limit increase in real time based on the received input data.

According to yet another aspect of the present disclosure, the method may further include: receiving input data from the card user computing device to reject the credit limit increase; modifying the threshold value data by the risk team computing device; and storing, onto the database, the modified threshold value data corresponding to the card user for future decision on approving the credit limit increase.

According to an additional aspect of the present disclosure, the method may further include: attaching a uniform resource locator (URL) link with the electronic notification; receiving user's consent data on increasing the credit limit based on clicking of the URL link; and automatically approving the credit limit increase in real time based on the received consent data.

According to a further aspect of the present disclosure, the method may further include: generating historical aggregate data based on prior transaction activities of the card user from a plurality of databases for transactions; integrating the transaction data with the historical aggregate data; executing a machine learning module using the integrated transaction data and the historical aggregate data to generate a fraud score; and determining whether the transaction data is fraudulent based on the generated fraud score.

According to yet another aspect of the present disclosure, the method may further include: authorizing the transaction data based on a positive determination that the fraud score is a value that is at or above a predetermined fraud threshold value; and simultaneously transmitting the electronic notification to the card user computing device in real time to notify that the card user is eligible for the credit limit increase based on the positive determination that the fraud score is a value that is at or above a predetermined fraud threshold value.

According to a further aspect of the present disclosure, the method may further include: denying the transaction data based on a negative determination that the fraud score is a value that is below a predetermined threshold; and simultaneously blocking transmission of the electronic notification to the card user computing device based on the negative determination that the fraud score is a value that is below a predetermined fraud threshold value.

According to yet another aspect of the present disclosure, the method may further include: transmitting another electronic notification to the card user computing device that a fraudulent transaction is detected; and receiving input data from the card user computing device confirming that the transaction is fraudulent.

According to an additional aspect of the present disclosure, the method may further include: transmitting another electronic notification to the card user computing device that a fraudulent transaction is detected; and receiving input data from the card user computing device confirming that the transaction is not fraudulent.

According to yet another aspect of the present disclosure, the method may further include: triggering a digital channel that leverages an existing application programming interface (API) to validate whether the card users are still eligible for the credit limit increase or not; and transmitting the electronic notification to the card user computing device in real time based on the validation.

According to another aspect of the present disclosure, a system for implementing a real time credit limit increase process is disclosed. The system may include: a database including memories that store historical data associated with card user information processor; and a processor operatively connected to the database via a communication link, wherein the processor may be configured to: cause a risk team computing device to access the database for receiving the historical data associated with card user information; apply rules on the historical data; electronically generate a file that includes data corresponding to card users who are eligible for a credit limit increase based on the applied rules on the historical data; transmit the file to a card servicing computing device; cause the card servicing computing device to validate that the card users are still eligible for the credit limit increase and maintain the file on the database based on validation; cause the card servicing computing device to receive transaction data originated at a point of sale terminal device when the card user initiates a card transaction; access the file from the database in real time to check whether the card user is among the card users who are eligible for a credit limit increase based on the received transaction data; determine whether the transaction data is equal to or above a predetermined threshold data; and transmit an electronic notification to a card user computing device in real time to notify that the card user is eligible for the credit limit increase based on a positive determination that the transaction data is equal to or above a predetermined threshold data.

According to a further aspect of the present disclosure, in transmitting the electronic notification, the processor may be further configured to: transmit the electronic notification to the card user computing device in real time in accordance with any one of the group consisting of SMS (Short Message Service), IM (Instant Message), and e-mail, but the disclosure is not limited thereto.

According to another aspect of the present disclosure, the processor may be further configured to: receive input data from the card user computing device to accept the credit limit increase; and automatically approve the credit limit increase in real time based on the received input data.

According to yet another aspect of the present disclosure, the processor may be further configured to: receive input data from the card user computing device to reject the credit limit increase; modify the threshold value data by the risk team computing device; and store, onto the database, the modified threshold value data corresponding to the card user for future decision on approving the credit limit increase.

According to an additional aspect of the present disclosure, the processor may be further configured to: attach a uniform resource locator (URL) link with the electronic notification; receive user's consent data on increasing the credit limit based on clicking of the URL link; and automatically approve the credit limit increase in real time based on the received consent data.

According to a further aspect of the present disclosure, the processor may be further configured to: generate historical aggregate data based on prior transaction activities of the card user from a plurality of databases for transactions; integrate the transaction data with the historical aggregate data; execute a machine learning module using the integrated transaction data and the historical aggregate data to generate a fraud score; and determine whether the transaction data is fraudulent based on the generated fraud score.

According to yet another aspect of the present disclosure, the processor may be further configured to: authorize the transaction data based on a positive determination that the fraud score is a value that is at or above a predetermined fraud threshold value; and simultaneously transmit the electronic notification to the card user computing device in real time to notify that the card user is eligible for the credit limit increase based on the positive determination that the fraud score is a value that is at or above a predetermined fraud threshold value.

According to a further aspect of the present disclosure, the processor may be further configured to: deny the transaction data based on a negative determination that the fraud score is a value that is below a predetermined threshold; and simultaneously block transmission of the electronic notification to the card user computing device based on the negative determination that the fraud score is a value that is below a predetermined fraud threshold value.

According to yet another aspect of the present disclosure, the processor may be further configured to: transmit another electronic notification to the card user computing device that a fraudulent transaction is detected; and receive input data from the card user computing device confirming that the transaction is fraudulent.

According to an additional aspect of the present disclosure, the processor may be further configured to: transmit another electronic notification to the card user computing device that a fraudulent transaction is detected; and receive input data from the card user computing device confirming that the transaction is not fraudulent.

According to yet another aspect of the present disclosure, the processor may be further configured to: trigger a digital channel that leverages an existing application programming interface (API) to validate whether the card users are still eligible for the credit limit increase or not; and transmit the electronic notification to the card user computing device in real time based on the validation.

According to a further aspect of the present disclosure, a non-transitory computer readable medium configured to store instructions for implementing a real time credit limit increase process is disclosed. The instructions, when executed, may cause a processor to perform the following: causing a risk team computing device to access a database for receiving historical data associated with card user information; applying rules on the historical data; electronically generating a file that includes data corresponding to card users who are eligible for a credit limit increase based on the applied rules on the historical data; transmitting the file to a card servicing computing device; causing the card servicing computing device to validate that the card users are still eligible for the credit limit increase and maintain the file on the database based on validation; causing the card servicing computing device to receive transaction data originated at a point of sale terminal device when the card user initiates a card transaction; accessing the file from the database in real time to check whether the card user is among the card users who are eligible for a credit limit increase based on the received transaction data; determining whether the transaction data is equal to or above a predetermined threshold data; and transmitting an electronic notification to a card user computing device in real time to notify that the card user is eligible for the credit limit increase based on a positive determination that the transaction data is equal to or above a predetermined threshold data.

According to a further aspect of the present disclosure, in transmitting the electronic notification, the instructions, when executed, may further cause the processor to perform the following: transmitting the electronic notification to the card user computing device in real time in accordance with any one of the group consisting of SMS (Short Message Service), IM (Instant Message), and e-mail, but the disclosure is not limited thereto.

According to another aspect of the present disclosure, the method may further include: receiving input data from the card user computing device to accept the credit limit increase; and automatically approving the credit limit increase in real time based on the received input data.

According to yet another aspect of the present disclosure, the instructions, when executed, may further cause the processor to perform the following: receiving input data from the card user computing device to reject the credit limit increase; modifying the threshold value data by the risk team computing device; and storing, onto the database, the modified threshold value data corresponding to the card user for future decision on approving the credit limit increase.

According to an additional aspect of the present disclosure, the instructions, when executed, may further cause the processor to perform the following: attaching a uniform resource locator (URL) link with the electronic notification; receiving user's consent data on increasing the credit limit based on clicking of the URL link; and automatically approving the credit limit increase in real time based on the received consent data.

According to a further aspect of the present disclosure, the instructions, when executed, may further cause the processor to perform the following: generating historical aggregate data based on prior transaction activities of the card user from a plurality of databases for transactions; integrating the transaction data with the historical aggregate data; executing a machine learning module using the integrated transaction data and the historical aggregate data to generate a fraud score; and determining whether the transaction data is fraudulent based on the generated fraud score.

According to yet another aspect of the present disclosure, the instructions, when executed, may further cause the processor to perform the following: authorizing the transaction data based on a positive determination that the fraud score is a value that is at or above a predetermined fraud threshold value; and simultaneously transmitting the electronic notification to the card user computing device in real time to notify that the card user is eligible for the credit limit increase based on the positive determination that the fraud score is a value that is at or above a predetermined fraud threshold value.

According to a further aspect of the present disclosure, the instructions, when executed, may further cause the processor to perform the following: denying the transaction data based on a negative determination that the fraud score is a value that is below a predetermined threshold; and simultaneously blocking transmission of the electronic notification to the card user computing device based on the negative determination that the fraud score is a value that is below a predetermined fraud threshold value.

According to yet another aspect of the present disclosure, the instructions, when executed, may further cause the processor to perform the following: transmitting another electronic notification to the card user computing device that a fraudulent transaction is detected; and receiving input data from the card user computing device confirming that the transaction is fraudulent.

According to an additional aspect of the present disclosure, the instructions, when executed, may further cause the processor to perform the following: transmitting another electronic notification to the card user computing device that a fraudulent transaction is detected; and receiving input data from the card user computing device confirming that the transaction is not fraudulent.

According to yet another aspect of the present disclosure, the instructions, when executed, may further cause the processor to perform the following: triggering a digital channel that leverages an existing application programming interface (API) to validate whether the card users are still eligible for the credit limit increase or not; and transmitting the electronic notification to the card user computing device in real time based on the validation.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a real time credit limit increase device in accordance with an exemplary embodiment.

FIG. 2 illustrates an exemplary diagram of a network environment for implementing a real time credit limit increase device in accordance with an exemplary embodiment.

FIG. 3 illustrates a system diagram for implementing a real time credit limit increase device with a real time credit limit increase module in accordance with an exemplary embodiment.

FIG. 4 illustrates a system diagram for implementing a real time credit limit increase module of FIG. 3 in accordance with an exemplary embodiment.

FIG. 5 illustrates a flow chart of a real time credit limit increase process by utilizing the system of FIG. 4 in accordance with an exemplary embodiment.

FIG. 6 illustrates another exemplary flow chart of a real time credit limit increase process by utilizing the system of FIG. 4 in accordance with an exemplary embodiment.

FIG. 7 illustrates an exemplary screenshot that describes prep-qualified customer data in accordance with an exemplary embodiment.

FIG. 8 illustrates an exemplary screenshot that describes an initial view of a database containing information of an offer in accordance with an exemplary embodiment.

FIG. 9 illustrates an exemplary screenshot that describes an offer sent to a customer in accordance with an exemplary embodiment.

FIG. 10 illustrates an exemplary screenshot that describes a database containing information of an offer after an offer is sent to a customer in accordance with an exemplary embodiment.

FIG. 11 illustrates an exemplary screenshot that describes a request to a customer to give consent to an offer utilizing a one-time password in accordance with an exemplary embodiment.

FIG. 12 illustrates an exemplary screenshot that describes a database containing information of customer giving consent to an offer by utilizing a one-time password in accordance with an exemplary embodiment.

FIG. 13 illustrates an exemplary screenshot that describes a customer giving consent and accepting an offer utilizing a one-time password in accordance with an exemplary embodiment.

FIG. 14 illustrates an exemplary screenshot that describes a notification to a customer of confirmation of accepting an offer in accordance with an exemplary embodiment.

FIG. 15 illustrates an exemplary screenshot that describes a database containing information of a customer accepting the offer in accordance with an exemplary embodiment.

FIG. 16 illustrates an exemplary screenshot that describes a notification to the customer that the offer has been completed in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

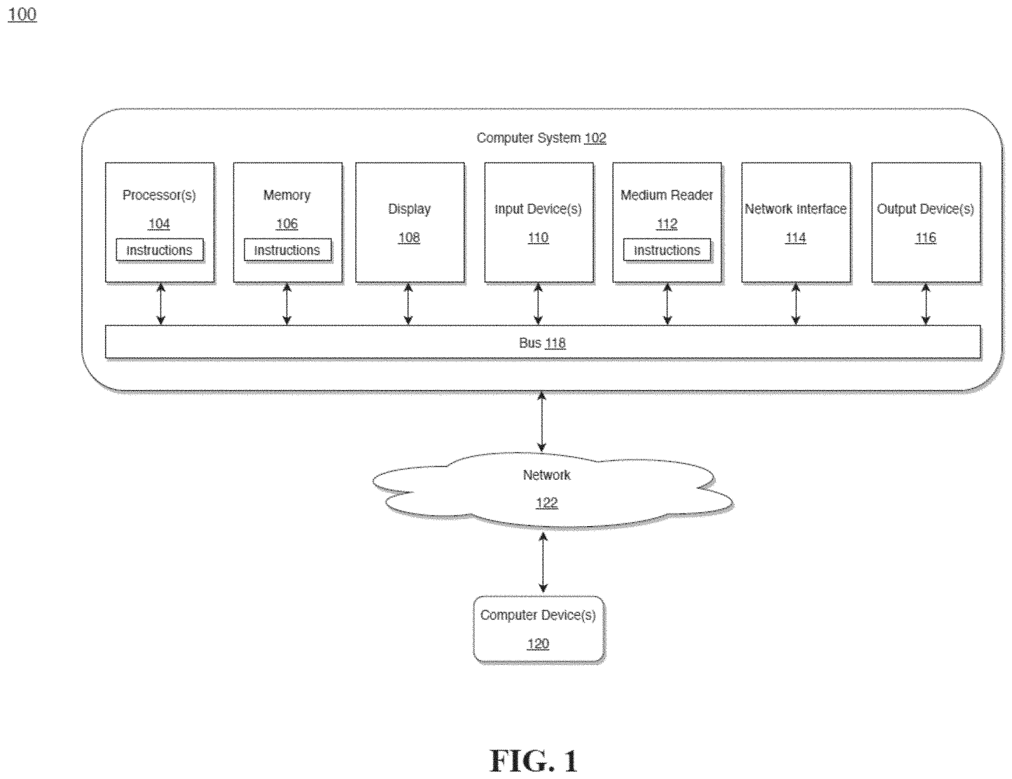

FIG. 1 is an exemplary system for use in real time credit limit increase process in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

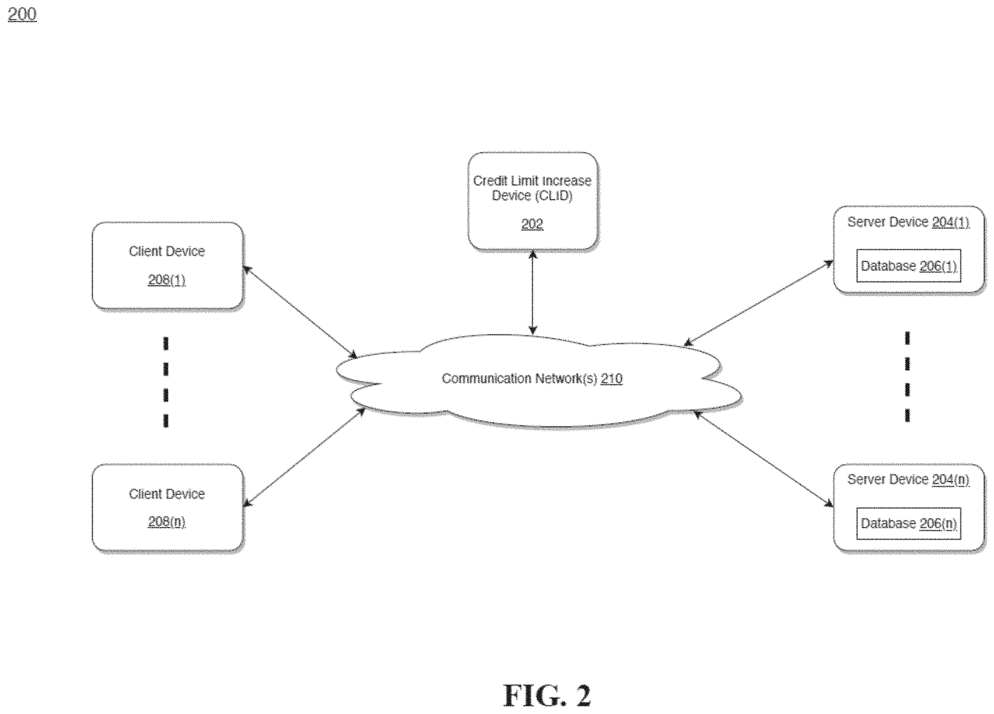

Referring to FIG. 2, a schematic of an exemplary network environment 200 for implementing a credit limit increase device for executing a real time credit limit increase process is illustrated. In an exemplary embodiment, the credit limit increase device is executable on any networked computer platform, such as, for example, a wireless mobile communication device, i.e., a smart phone.

The credit limit increase device (CLID) 202 may be the same or similar to the computer system 102 as described with respect to FIG. 1. The CLID 202 may store one or more applications that can include executable instructions that, when executed by the CLID 202, cause the CLID 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s), or through a collection of micro-services that may be managed in a cloud-based computing environment. Also, the application(s) and some non-real time analytical functions performed by the CLID 202 itself, may be located in virtual server(s) running in a cloud-based computing environment rather than being tied to one or more specific physical network computing devices. Also, the application(s) may be running in one or more virtual machines (VMs) executing on the CLID 202. Additionally, in one or more embodiments of this technology, virtual machine(s) or micro-services running on the CLID 202 may be managed or supervised by a hypervisor or service orchestration functions.

In the network environment 200 of FIG. 2, the CLID 202 is coupled to a plurality of server devices 204(1)-204(n) that hosts a plurality of databases 206(1)-206(n), and also to a plurality of client devices 208(1)-208(n) via communication network(s) 210. A communication interface of the CLID 202, such as the network interface 114 of the computer system 102 of FIG. 1, operatively couples and communicates between the CLID 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CLID 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and integrated healthcare management devices that efficiently manage healthcare integration.

By way of example only, the communication network(s) 210 may include local area network(s) (LAN(s)) or wide area network(s) (WAN(s)), and can use TCP/IP over Ethernet and industry-standard transmission media and protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CLID 202 may be a standalone device or integrated with one or more other devices or apparatuses, such as one or more of the server devices 204(1)-204(n), for example. In one particular example, the CLID 202 may include or be hosted by one of the server devices 204(1)-204(n), and other arrangements are also possible. Moreover, one or more of the devices of the CLID 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CLID 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store patient health data, medication data, and treatment data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can facilitate the integration of healthcare expenses management. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CLID 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the CLID 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CLID 202, the server devices 204(1)-204(n), or the client devices 208(1)-208(n), for example, may be configured to operate as virtual instances on the same physical machine. In other words, one or more of the CLID 202, the server devices 204(1)-204(n), or the client devices 208(1)-208(n) may operate on the same physical device rather than as separate devices communicating through communication network(s) 210. Additionally, there may be more or fewer CLIDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

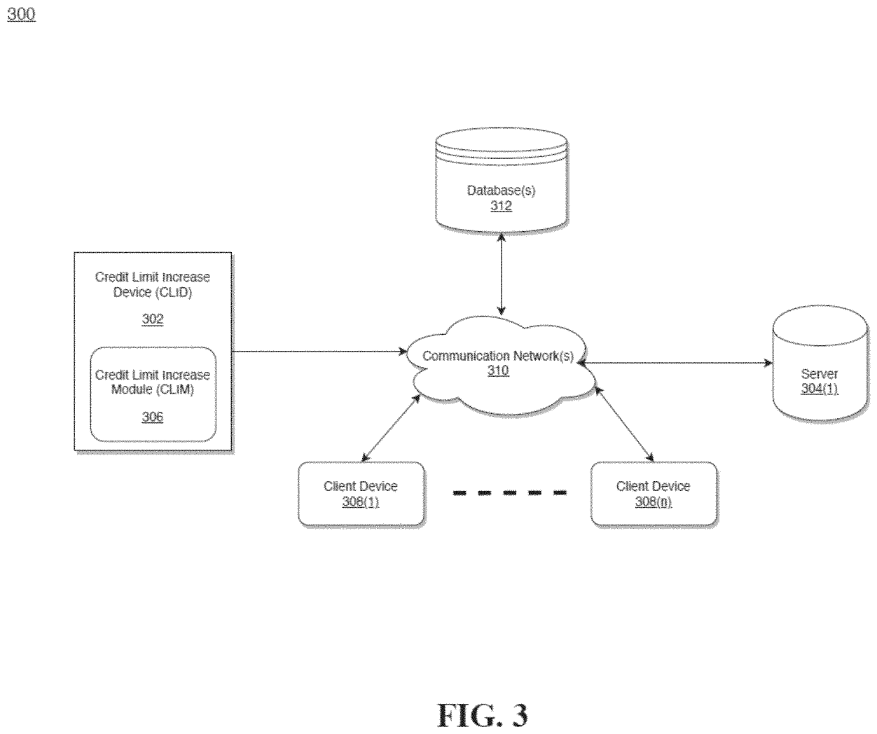

FIG. 3 illustrates a system diagram for implementing a real time credit limit increase device with a real time credit limit increase module in accordance with an exemplary embodiment.

The credit limit increase device (CLID) 302 is described and shown in FIG. 3 as including a credit limit increase module (CLIM) 306, although it may include other rules, policies, modules, databases, or applications, for example. As will be described below, the CLIM 306 is configured to retrieve information from the database(s) 312 and server 304(1) for appropriately implementing a credit limit increase process in real time.

According to exemplary embodiments, the CLID 302, the database(s) 312, the first client device 308(1), the second client device 308(n), the server 304(1), and the network 310 as illustrated in FIG. 3 may be the same or similar to the CLID 202, the database 206(1)-206(n), the first client device 208(1), the second client device 208(2), the server 204(1), and the network 210, respectively, as illustrated in FIG. 2.

An exemplary process 300 for implementing a credit limit increase process in real time by utilizing the network environment of FIG. 2 is shown as being executed in FIG. 3. Specifically, a first client device 308(1) and a second client device 308(n) are illustrated as being in communication with CLID 302. In this regard, the first client device 308(1) and the second client device 308(n) may be “clients” of the CLID 302 and are described herein as such. Nevertheless, it is to be known and understood that the first client device 308(1) and/or the second client device 308(n) need not necessarily be “clients” of the CLID 302, or any entity described in association therewith herein. Any additional or alternative relationship may exist between either or both of the first client device 308(1) and the second client device 308(2) and the CLID 302, or no relationship may exist.

Further, CLID 302 is illustrated as being able to access the database(s) 312 and server 304(1). The CLIM 306 may also be configured to access these databases 312 and server 304(1) for implementing a credit limit increase process in real time.

The first client device 308(1) may be, for example, a smart phone, a personal computer (PC). Of course, the first client device 308(1) may be any additional device described herein. The second client device 308(n) may be, for example, a PC. Of course, the second client device 308(2) may also be any additional device described herein.

The process may be executed via the communication network(s) 310, which may comprise plural networks as described above. For example, in an exemplary embodiment, either or both of the first client device 308(1) and the second client device 308(n) may communicate with the CLID 302 via broadband or cellular communication. Of course, these embodiments are merely exemplary and are not limiting or exhaustive.

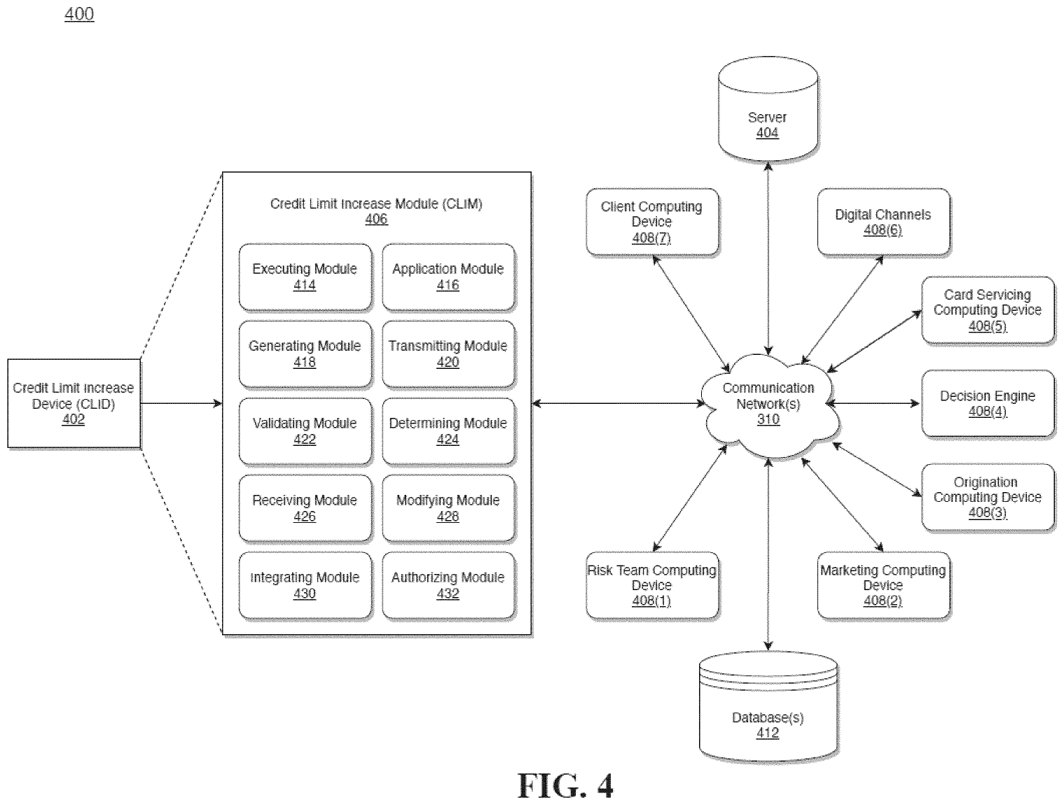

FIG. 4 shows a system 400 for implementing a real time CLID having a real time CLIM of FIG. 3, according to an example embodiment. As illustrated in FIG. 4, a CLIM 406 may be embedded within a CLID 402. According exemplary embodiments, the CLIM 406 and the CLID 402 as illustrated in FIG. 4 may be the same or similar to the CLIM 306 and the CLID 302, respectively, as illustrated in FIG. 3.

The CLIM 406 may include an executing module 414, an application module 416, a generating module 418, a transmitting module 420, a validating module 422, a determining module 424, a receiving module 426, a modifying module 428, an integrating module 430, and an authorizing module 432.

According to exemplary embodiments, each of the executing module 414, application module 416, generating module 418, transmitting module 420, validating module 422, determining module 424, receiving module 426, modifying module 428, integrating module 430, and the authorizing module 432 may be implemented by microprocessors or similar, they may be programmed using software (e.g., microcode) to perform various functions discussed herein and may optionally be driven by firmware and/or software. Alternatively, each of the executing module 414, application module 416, generating module 418, transmitting module 420, validating module 422, determining module 424, receiving module 426, modifying module 428, integrating module 430, and the authorizing module 432 may be implemented by dedicated hardware, or as a combination of dedicated hardware to perform some functions and a processor (e.g., one or more programmed microprocessors and associated circuitry) to perform other functions. Also, according to exemplary embodiments, each of the executing module 414, application module 416, generating module 418, transmitting module 420, validating module 422, determining module 424, receiving module 426, modifying module 428, integrating module 430, and the authorizing module 432 may be physically separated into two or more interacting and discrete blocks, units, devices, and/or modules without departing from the scope of the inventive concepts.

According to exemplary embodiments, each of the executing module 414, application module 416, generating module 418, transmitting module 420, validating module 422, determining module 424, receiving module 426, modifying module 428, integrating module 430, and the authorizing module 432 of the CLIM 406 may be called via corresponding API.

FIG. 4 also illustrates a risk team computing device 408(1), a marketing computing device 408(2), an origination computing device 408(3), a decision engine 408(4), a card servicing computing device 408(5), digital channels 408(6), and a client computing device 408(7) interconnected with each other via the communication network(s) 310. As illustrated in FIG. 4, the CLID 402 including the CLIM 406 are also connected with the risk team computing device 408(1), marketing computing device 408(2), origination computing device 408(3), decision engine 408(4), card servicing computing device 408(5), digital channels 408(6), and the client computing device 408(7) via the communication network 310.

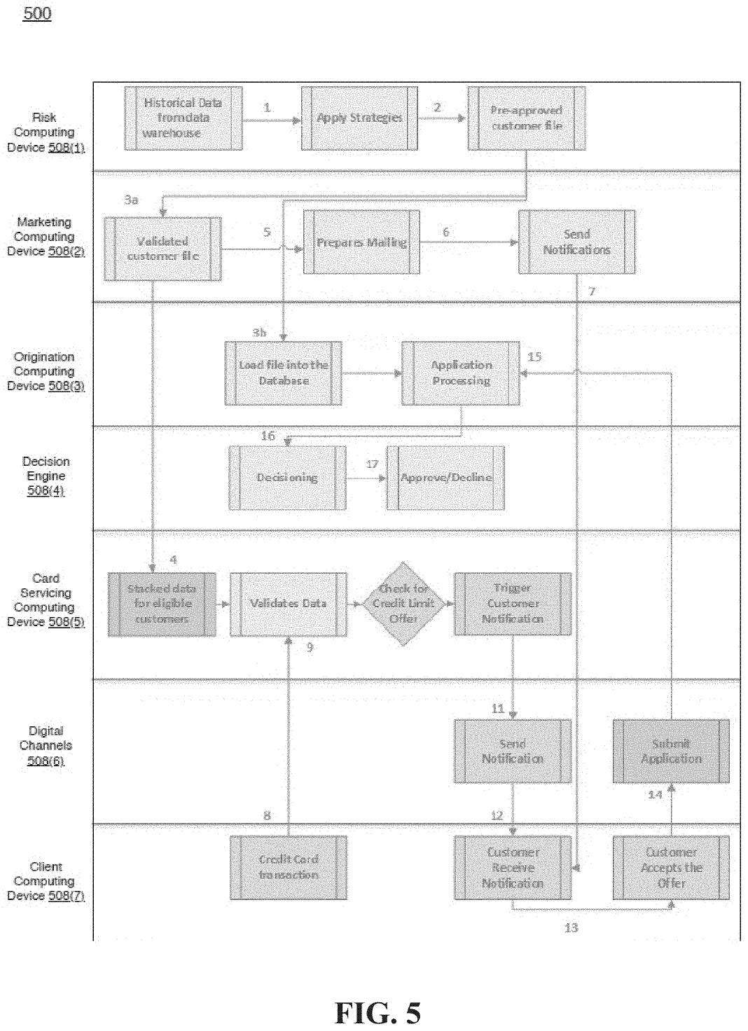

FIG. 5 illustrates a flow chart 500 of a real time credit limit increase process by utilizing the system of FIG. 4 in accordance with an exemplary embodiment where functionalities of each of a risk team computing device 508(1), a marketing computing device 508(2), an origination computing device 508(3), a decision engine 508(4), a card servicing computing device 508(5), digital channels 508(6), and a client computing device 508(7). The risk team computing device 508(1), marketing computing device 508(2), origination computing device 508(3), decision engine 508(4), card servicing computing device 508(5), digital channels 508(6), and the client computing device 508(7) as illustrated in FIG. 5 is the same or similar to the risk team computing device 408(1), marketing computing device 408(2), origination computing device 408(3), decision engine 408(4), card servicing computing device 408(5), digital channels 408(6), and the client computing device 408(7), respectively, as illustrated in FIG. 4.

Referring to FIGS. 4 and 5, according to exemplary embodiments, the executing module may be configured to cause a risk team computing device 408(1), 508(1) to access a database 412 and/or server 404 for receiving historical data associated with card user information. The application module 416 may be configured to apply rules on the historical data. The generating module 418 may be configured to electronically generating a file that includes data corresponding to card users who are eligible for a credit limit increase based on the applied rules on the historical data.

According to exemplary embodiments, the transmitting module 420 may be configured to transmit the file to a card servicing computing device 408(5), 508(5). The validating module 422 may be configured to cause the card servicing computing device 408(5), 508(5) to validate that the card users are still eligible for the credit limit increase and maintain the file on the database 412 and/or server 404 based on validation. The receiving module 426 may be configured to cause the card servicing computing device (e.g., client computing device 408(5), 508(5)) to receive transaction data originated at a point of sale terminal device when the card user initiates a card transaction.

According to exemplary embodiments, the executing module 414 may be configured to access the file from the database 412 and/or server 404 in real time to check whether the card user is among the card users who are eligible for a credit limit increase based on the received transaction data.

According to exemplary embodiments, the determining module 424 may be configured to determine whether the transaction data is equal to or above a predetermined threshold data. The transmitting module 420 may be configured to transmit an electronic notification to a card user computing device (e.g., client computing device 408(5), 508(5)) in real time to notify that the card user is eligible for the credit limit increase based on a positive determination by the determining module 424 that the transaction data is equal to or above a predetermined threshold data.

According to exemplary embodiments, the transmitting module 420 may be configured to transmit the electronic notification to the card user computing device (e.g., client computing device 408(5), 508(5)) in real time in accordance with any one of the group consisting of SMS (Short Message Service), IM (Instant Message), and e-mail, but the disclosure is not limited thereto.

According to exemplary embodiments, the receiving module 426 may be configured to receive input data from the card user computing device (e.g., client computing device 408(5), 508(5)) to accept the credit limit increase. The authorizing module 432 may be configured to automatically approve the credit limit increase in real time based on the received input data.

According to exemplary embodiments, the receiving module 426 may be configured to receive input data from the card user computing device (e.g., client computing device 408(5), 508(5)) to reject the credit limit increase. The modifying module 428 may be configured to modify the threshold value data by the risk team computing device 408(1), 508(1). The modified threshold value data may be stored onto the database 412 and/or the server 404. According to exemplary embodiments, the modified threshold value data may correspond to the card user for future decision on approving the credit limit increase.

According to exemplary embodiments, the executing module 414 may be configured to attach a uniform resource locator (URL) link with the electronic notification. The receiving module 426 may be configured to receive user's consent data on increasing the credit limit based on clicking of the URL link. The authorizing module 432 may be configured to automatically approve the credit limit increase in real time based on the received consent data.

According to exemplary embodiments, the generating module 418 may be configured to generate historical aggregate data based on prior transaction activities of the card user from a plurality of databases 412 and/or servers 404 for transactions. The integrating module 430 may be configured to integrate the transaction data with the historical aggregate data. The executing module 414 may be configured to execute a machine learning module using the integrated transaction data and the historical aggregate data to generate a fraud score. The determining module 424 may be configured to determine whether the transaction data is fraudulent based on the generated fraud score.

According to exemplary embodiments, the authorizing module 432 may be configured to authorize the transaction data based on a positive determination by the determining module 424 that the fraud score is a value that is at or above a predetermined fraud threshold value. The transmitting module 420 may be configured to simultaneously transmit the electronic notification to the card user computing device (e.g., client computing device 408(5), 508(5)) in real time to notify that the card user is eligible for the credit limit increase based on the positive determination by the determining module 424 that the fraud score is a value that is at or above a predetermined fraud threshold value.

According to exemplary embodiments, authorizing module 432 may be configured to deny the transaction data based on a negative determination by the determining module 424 that the fraud score is a value that is below a predetermined threshold. The executing module 414 may be configured to simultaneously block transmission of the electronic notification to the card user computing device (e.g., client computing device 408(5), 508(5)) based on the negative determination by the determining module 424 that the fraud score is a value that is below a predetermined fraud threshold value.

According to exemplary embodiments, the transmitting module 420 may be configured to transmit another electronic notification to the card user computing device (e.g., client computing device 408(5), 508(5)) that a fraudulent transaction is detected. The receiving module 426 may be configured to receive input data from the card user computing device (e.g., client computing device 408(5), 508(5)) confirming that the transaction is fraudulent.

According to exemplary embodiments, the transmitting module 420 may be configured to transmit another electronic notification to the card user computing device (e.g., client computing device 408(5), 508(5)) that a fraudulent transaction is detected. The receiving module 426 may be configured to receive input data from the card user computing device (e.g., client computing device 408(5), 508(5)) confirming that the transaction is not fraudulent.

According to exemplary embodiments, the executing module 414 may be configured to trigger a digital channel 408(6) that leverages an existing application programming interface (API) to validate whether the card users are still eligible for the credit limit increase or not. The transmitting module 420 may be configured to transmit the electronic notification to the card user computing device (e.g., client computing device 408(5), 508(5)) in real time based on the validation.

Referring back to FIGS. 4 and 5 again, an exemplary flow of a real time process 500 of credit limit increase will be discussed below.

According to exemplary embodiments, at step 1, a risk team computing device 508(1) may receive the historical data from the database 412. At step 2, the risk team computing device applies strategies on the historical data and prepares a file that has customer information who all are eligible for credit limit increase then sends the eligible customer file to a marketing computing device 508(2) and origination computing device 508(3). At step 3, the marketing computing device 508(2) utilizes the eligible customer file for preparing mailing and send notifications. At step 3b, the origination computing device 508(3) may receive the eligible customer file on a monthly basis and may refresh the eligible customer file every week to eliminate customers who are no longer eligible.

According to exemplary embodiments, at step 4 of process 500, the eligible customer file may be prepared based on the historical data, and sent to the card servicing computing device 508(5) to validate if the customers are still eligible for credit limit increase, and then update the servicing feature to maintain the file in the database 412 and/or server 404.

According to exemplary embodiments, at step 5 of process 500, the marketing computing device 508(2) may prepare mailing to send the emails (or other electronic messaging communications) to qualifying customers.

According to exemplary embodiments, at step 6 of process 500, the marketing computing device 508(2) may send out offers via email notifications (or other electronic messaging communications) to eligible customers offering them the credit limit increase.

According to exemplary embodiments, at step 7 of process 500, after receiving notifications, customer may login to digital channels 508(6) and apply for credit limit increase.

According to exemplary embodiments, at step 8 of process 500, when the customer makes a transaction using a credit card, it goes to card servicing computing device 508(5) for approval/authentication.

According to exemplary embodiments, at step 9 of process 500, the card servicing computing device adds new feature in card servicing to check if the customer is eligible for the offer by looking up into eligible customer database (e.g., database 412 or server 404).

According to exemplary embodiments, at step 10 of process 500, if the customer is eligible and reached a threshold, a notification event will be triggered from card servicing computing device 508(5) to the digital channel 508(6). The threshold may be decided by the risk computing device 508(1) and may be flexible.

According to exemplary embodiments, at step 11 of process 500, the digital channel 508(6) may leverage an existing API to originations (i.e., to origination computing device 508(3) and validate if the customers are still eligible for the offer or not and trigger notification to customer (i.e., to the client computing device 508(7)).

According to exemplary embodiments, at step 12 of process 500, the customer computing device 508(7) may receive a notification indicating offer details and link to opt for accepting the offer.

According to exemplary embodiments, at step 13 of process 500, the customer can accept the offer by clicking the link provided, which may be directed to the digital channel 508(6).

According to exemplary embodiments, at step 14 of process 500, as soon as customer gives a consent, an application would be submitted to the origination computing device 508(3) in the background to increase the credit limit.

According to exemplary embodiments, at step 15 of process 500, the applications may be processed by origination computing device 508(3) by getting required information from fraud, decision engines (e.g., decision engine 508(4)) etc.

According to exemplary embodiments, at step 16 of process 500, a decision is made by the decision engine 508(4) and at step 17 of process 500, the applications are approved or declined based on the results of the decision engine 508(4).

Referring back to FIGS. 4 and 5 again, the CLIM 406 may be configured to add new capability to load the pre-qualified customers to card servicing database by utilizing Java Springboot, Microservice API, etc., but the disclosure is not limited thereto

In addition to real time credit limit increase, the CILM 406 may be leveraged for other capabilities as follows:

Post purchase: When a customer does a transaction, will get a real time alert (SMS/Email) to convert due amount into EMIs.

Pre Purchase: When a customer leaves a transaction half complete, a bank can send them the SMS/email if the customer wants to continue where the customer left the transaction may allow the customer to complete the transaction.

When a customer does a transaction which makes them eligible to avail a benefit or promotions and how they can redeem it. An SMS/Email can be sent in real time making the customer aware that they have won or eligible for a promotion.

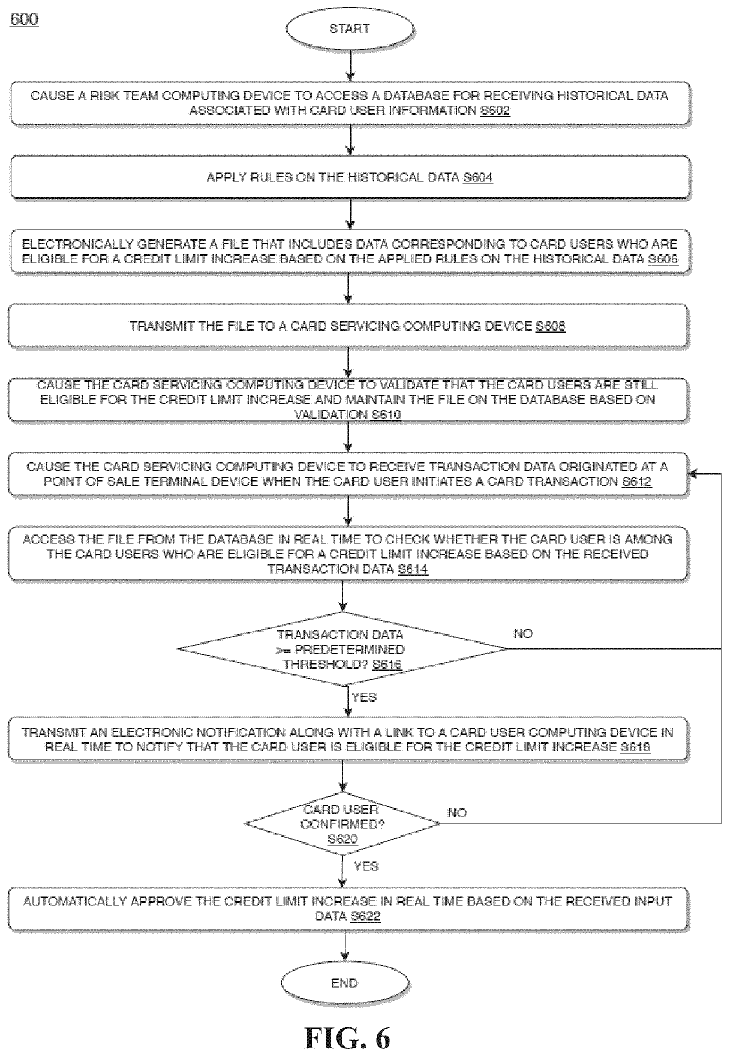

FIG. 6 illustrates another exemplary flow chart of a real time credit limit increase process by utilizing the system of FIG. 4 in accordance with an exemplary embodiment.

In the process 600 of FIG. 6, at step S602, the CLIM 406 may cause a risk team computing device to access a database for receiving historical data associated with card user information.

At step S604, the CLIM 406 may apply rules on the historical data. At step S606, the CLIM 406 may electronically generate a file that includes data corresponding to card users who are eligible for a credit limit increase based on the applied rules on the historical data.

At step S608, the file may be transmitted to a card servicing computing device and at step S610, the card servicing computing device may validate that the card users are still eligible for the credit limit increase and maintain the file on the database based on validation.

At step S612, the card servicing computing device may receive transaction data originated at a point of sale terminal device when the card user initiates a card transaction. At step S614, the file may be accessed from the database in real time to check whether the card user is among the card users who are eligible for a credit limit increase based on the received transaction data.

At step S616, it may be determined whether the transaction data is equal to or above a predetermined threshold data. If at step S616, it is determined that the transaction data is equal to or above a predetermined threshold data, at step S618, an electronic notification along with link to a card user computing device in real time to notify that the card user is eligible for the credit limit increase. If, however, at step S616, it is determined that the transaction data is less than a predetermined threshold data, the process 660 goes back to step S612.

At step S620, it is determined whether the card user confirmed to accept the offer by clicking the link. If at S620, it is determined that the card user confirmed to accept the offer by clicking the link, at step S622, the process 600 automatically approve the credit limit increase in real time based on the received input data. If, however, at S620 it is determined that the card user did not confirmed to accept the offer (i.e., did not click the link), the process 600 goes back to step 612.

According to exemplary embodiments, wherein in the process 600, transmitting the electronic notification may include transmitting the electronic notification to the card user computing device in real time in accordance with any one of the group consisting of SMS (Short Message Service), IM (Instant Message), and e-mail, but the disclosure is not limited thereto.

According to exemplary embodiments, the process 600 may further include: receiving input data from the card user computing device to accept the credit limit increase; and automatically approving the credit limit increase in real time based on the received input data.

According to exemplary embodiments, the process 600 may further include: receiving input data from the card user computing device to reject the credit limit increase; modifying the threshold value data by the risk team computing device; and storing, onto the database, the modified threshold value data corresponding to the card user for future decision on approving the credit limit increase.

According to exemplary embodiments, the process 600 may further include: attaching a uniform resource locator (URL) link with the electronic notification; receiving user's consent data on increasing the credit limit based on clicking of the URL link; and automatically approving the credit limit increase in real time based on the received consent data.

According to exemplary embodiments, the process 600 may further include: generating historical aggregate data based on prior transaction activities of the card user from a plurality of databases for transactions; integrating the transaction data with the historical aggregate data; executing a machine learning module using the integrated transaction data and the historical aggregate data to generate a fraud score; and determining whether the transaction data is fraudulent based on the generated fraud score.

According to exemplary embodiments, the process 600 may further include: authorizing the transaction data based on a positive determination that the fraud score is a value that is at or above a predetermined fraud threshold value; and simultaneously transmitting the electronic notification to the card user computing device in real time to notify that the card user is eligible for the credit limit increase based on the positive determination that the fraud score is a value that is at or above a predetermined fraud threshold value.

According to exemplary embodiments, the process 600 may further include: denying the transaction data based on a negative determination that the fraud score is a value that is below a predetermined threshold; and simultaneously blocking transmission of the electronic notification to the card user computing device based on the negative determination that the fraud score is a value that is below a predetermined fraud threshold value.

According to exemplary embodiments, the process 600 may further include: transmitting another electronic notification to the card user computing device that a fraudulent transaction is detected; and receiving input data from the card user computing device confirming that the transaction is fraudulent.

According to exemplary embodiments, the process 600 may further include: transmitting another electronic notification to the card user computing device that a fraudulent transaction is detected; and receiving input data from the card user computing device confirming that the transaction is not fraudulent.

According to exemplary embodiments, the process 600 may further include: triggering a digital channel that leverages an existing application programming interface (API) to validate whether the card users are still eligible for the credit limit increase or not; and transmitting the electronic notification to the card user computing device in real time based on the validation.

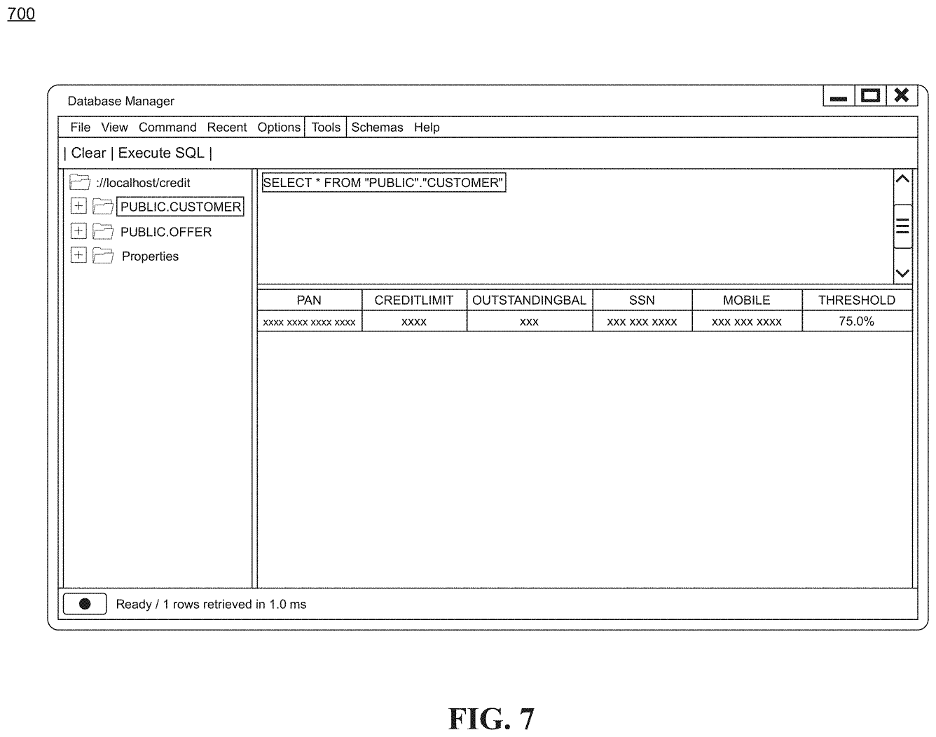

FIG. 7 illustrates an exemplary screenshot 700 that describes prep-qualified customer data in accordance with an exemplary embodiment. As illustrated is FIG. 7, the screenshot 700 illustrates a table containing a column for personal account number (PAN) that may store a customer's credit card number. The table may also include a column for credit limit (CREDITLIMIT) which may contain the current credit limit of the customer. The table may also include an outstanding balance (OUTSTANDINGBAL) that may store the customer's current balance. The table may also include columns for social security number (SSN) and mobile phone number (MOBILE) which contain the customer's personal information. The table may further include a column for threshold (THRESHOLD) which is the percentage limit to which an offer notification message is sent to the customer. However the arrangement and contents of the columns are not limited thereto.

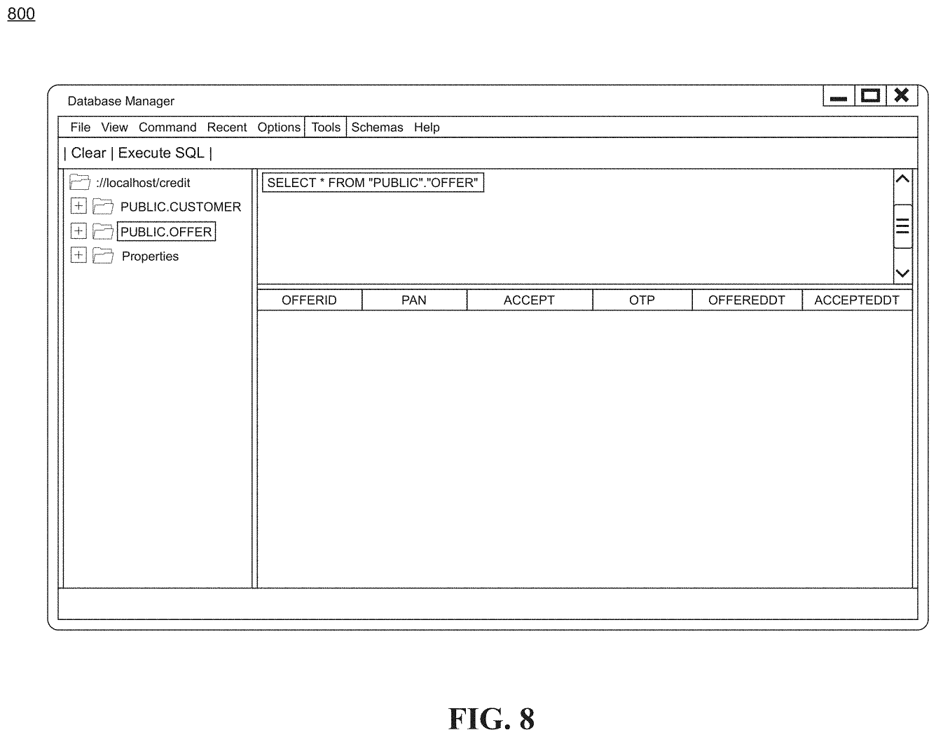

FIG. 8 illustrates an exemplary screenshot 800 that describes an initial view of a database containing information of an offer in accordance with an exemplary embodiment. As illustrated is FIG. 8, the screenshot 800 illustrates a table containing a column for offer ID (OFFERID), a column for personal account number (PAN), a column for whether a customer has accepted the offer, a column for one time password (OTP), a column for offered date and time (OFFERDDT), and a column for accepted date and time (ACCEPTEDDT), but the disclosure is not limited thereto.

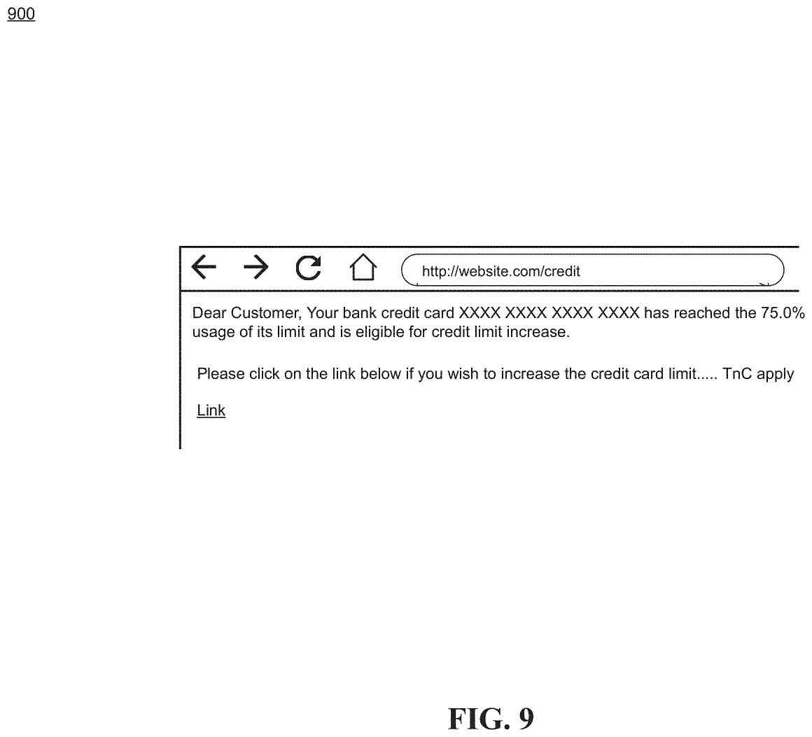

FIG. 9 illustrates an exemplary screenshot 900 that describes an offer sent to a customer in accordance with an exemplary embodiment. As illustrated is FIG. 9, the screenshot 900 illustrates that the offer was sent to the customer when customer's credit limit has reached a predetermined threshold, i.e., 75.0%, but the disclosure is not limited thereto. Also a link may be provided for the customer to view the offer.

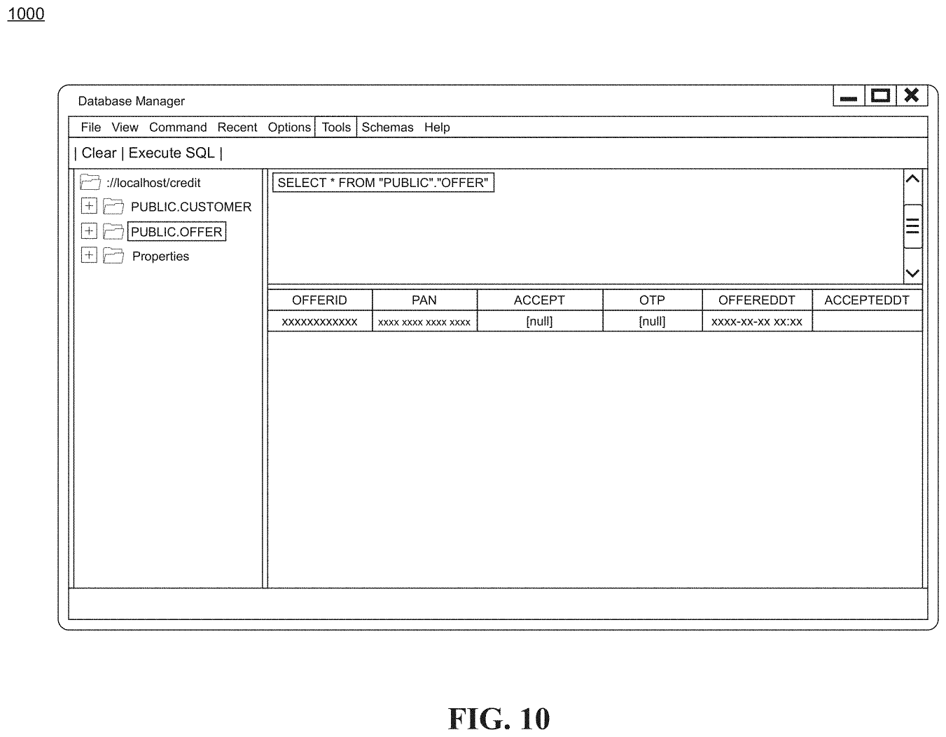

FIG. 10 illustrates an exemplary screenshot 1000 that describes a database containing information of an offer after an offer is sent to a customer in accordance with an exemplary embodiment. As illustrated is FIG. 10, the screenshot 1000 illustrates the database with the date and time of the offer.

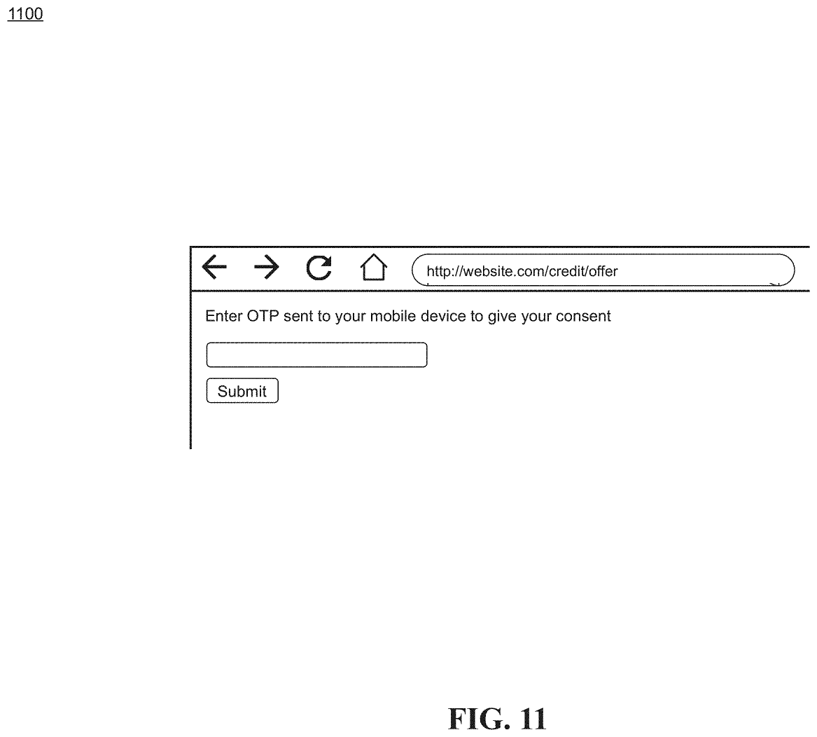

FIG. 11 illustrates an exemplary screenshot 1100 that describes a request to a customer to give consent to an offer utilizing a one-time password in accordance with an exemplary embodiment. As illustrated is FIG. 11, the screenshot 1100 illustrates a data entry field and a submit button for the customer to consent.

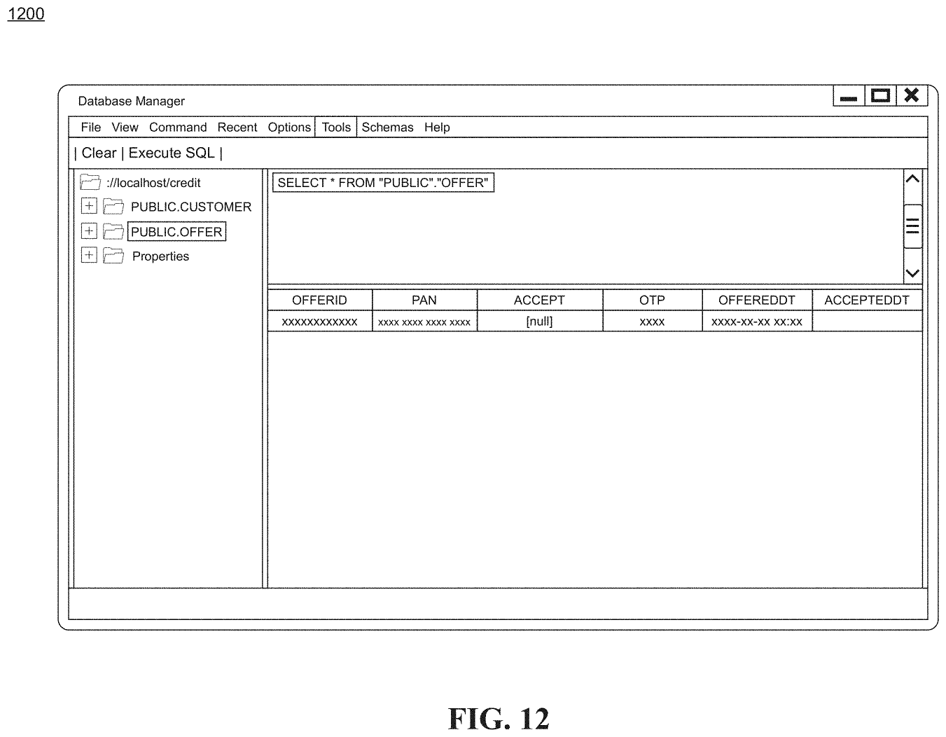

FIG. 12 illustrates an exemplary screenshot 1200 that describes a database containing information of customer giving consent to an offer by utilizing a one-time password in accordance with an exemplary embodiment. As illustrated is FIG. 12, the screenshot 1200 illustrates the database with the one-time password.

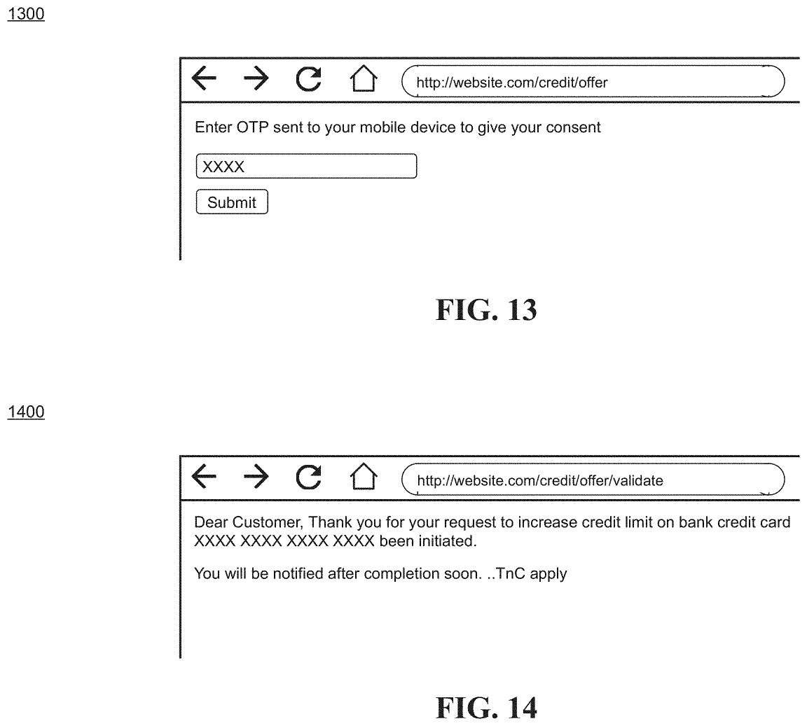

FIG. 13 illustrates an exemplary screenshot 1300 that describes a customer giving consent and accepting an offer utilizing a one-time password in accordance with an exemplary embodiment. As illustrated is FIG. 13, the screenshot 1300 illustrates the one-time password entered to the data entry field in FIG. 11.

FIG. 14 illustrates an exemplary screenshot 1400 that describes a notification to a customer of confirmation of accepting an offer in accordance with an exemplary embodiment.

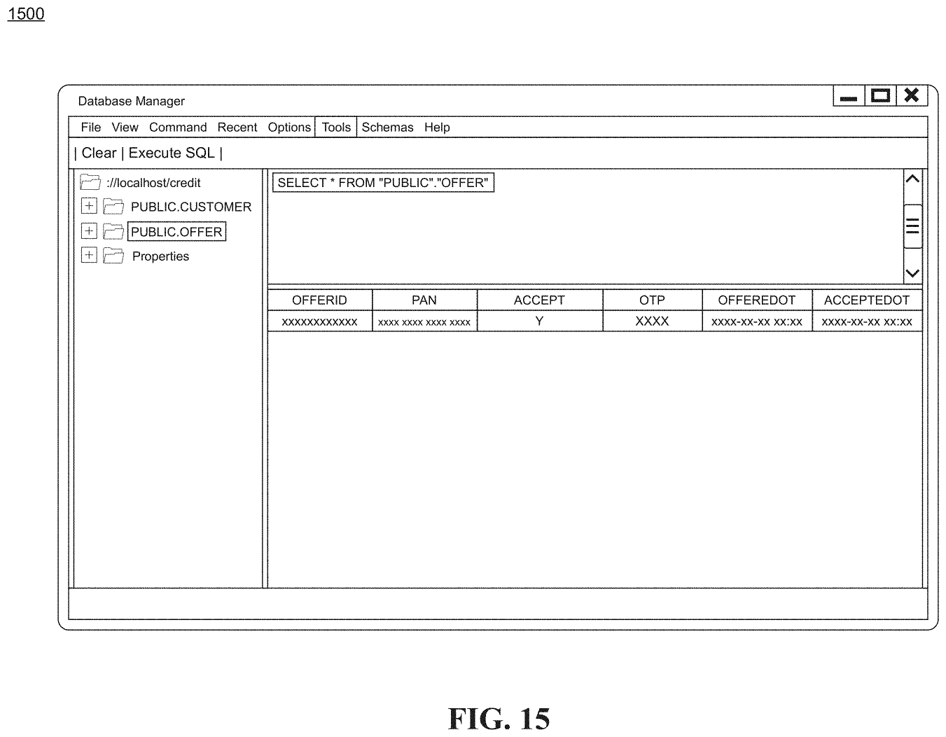

FIG. 15 illustrates an exemplary screenshot 1500 that describes a database containing information of a customer accepting the offer in accordance with an exemplary embodiment. As illustrated is FIG. 15, the screenshot 1500 illustrates the database that shows acceptance of the offer (Y).

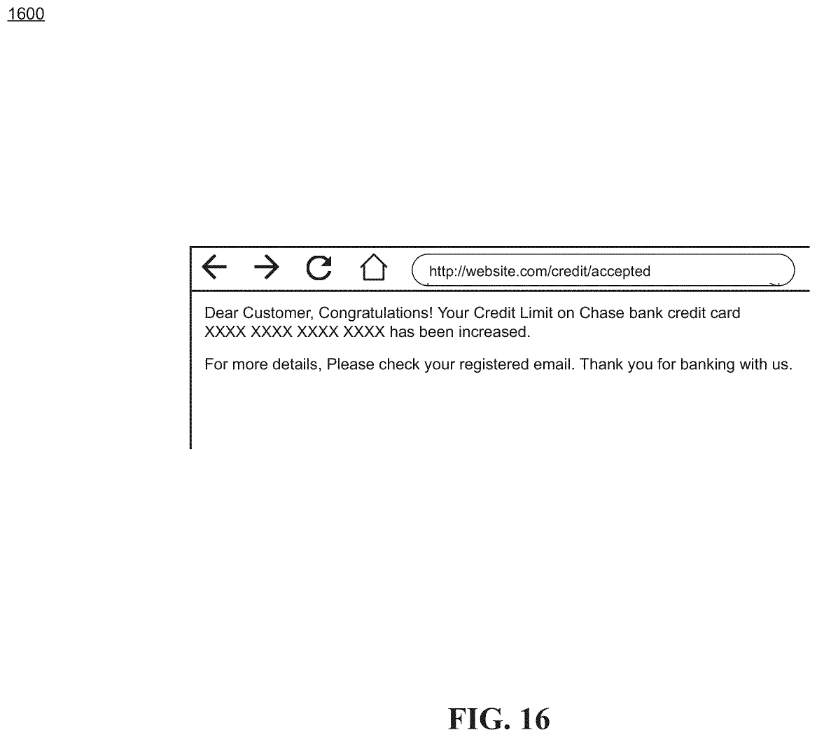

FIG. 16 illustrates an exemplary screenshot 1600 that describes a notification to the customer that the offer has been completed in accordance with an exemplary embodiment.

According to exemplary embodiments, a non-transitory computer readable medium may be configured to store instructions for implementing a real time credit limit increase process, implemented by a processor, to perform the processes disclosed above. The processor may be the same or similar to the processor 104 as illustrated in FIG. 1 or the processor embedded within the CLID 202, CLID 302, CLIM 306, CLID 402, and CLIM 406.

For example, the instructions, when executed, may cause the processor 104 to perform the following: causing a risk team computing device to access a database for receiving historical data associated with card user information; applying rules on the historical data; electronically generating a file that includes data corresponding to card users who are eligible for a credit limit increase based on the applied rules on the historical data; transmitting the file to a card servicing computing device; causing the card servicing computing device to validate that the card users are still eligible for the credit limit increase and maintain the file on the database based on validation; causing the card servicing computing device to receive transaction data originated at a point of sale terminal device when the card user initiates a card transaction; accessing the file from the database in real time to check whether the card user is among the card users who are eligible for a credit limit increase based on the received transaction data; determining whether the transaction data is equal to or above a predetermined threshold data; and transmitting an electronic notification to a card user computing device in real time to notify that the card user is eligible for the credit limit increase based on a positive determination that the transaction data is equal to or above a predetermined threshold data.

According to exemplary embodiments, wherein the instructions, when executed, may further cause the processor 104 to perform the following: transmitting the electronic notification may include transmitting the electronic notification to the card user computing device in real time in accordance with any one of the group consisting of SMS (Short Message Service), IM (Instant Message), and e-mail, but the disclosure is not limited thereto.

According to exemplary embodiments, wherein the instructions, when executed, may further cause the processor 104 to perform the following: receiving input data from the card user computing device to accept the credit limit increase; and automatically approving the credit limit increase in real time based on the received input data.

According to exemplary embodiments, wherein the instructions, when executed, may further cause the processor 104 to perform the following: receiving input data from the card user computing device to reject the credit limit increase; modifying the threshold value data by the risk team computing device; and storing, onto the database, the modified threshold value data corresponding to the card user for future decision on approving the credit limit increase.

According to exemplary embodiments, wherein the instructions, when executed, may further cause the processor 104 to perform the following: attaching a uniform resource locator (URL) link with the electronic notification; receiving user's consent data on increasing the credit limit based on clicking of the URL link; and automatically approving the credit limit increase in real time based on the received consent data.

According to exemplary embodiments, wherein the instructions, when executed, may further cause the processor 104 to perform the following: generating historical aggregate data based on prior transaction activities of the card user from a plurality of databases for transactions; integrating the transaction data with the historical aggregate data; executing a machine learning module using the integrated transaction data and the historical aggregate data to generate a fraud score; and determining whether the transaction data is fraudulent based on the generated fraud score.

According to exemplary embodiments, wherein the instructions, when executed, may further cause the processor 104 to perform the following: authorizing the transaction data based on a positive determination that the fraud score is a value that is at or above a predetermined fraud threshold value; and simultaneously transmitting the electronic notification to the card user computing device in real time to notify that the card user is eligible for the credit limit increase based on the positive determination that the fraud score is a value that is at or above a predetermined fraud threshold value.

According to exemplary embodiments, wherein the instructions, when executed, may further cause the processor 104 to perform the following: denying the transaction data based on a negative determination that the fraud score is a value that is below a predetermined threshold; and simultaneously blocking transmission of the electronic notification to the card user computing device based on the negative determination that the fraud score is a value that is below a predetermined fraud threshold value.

According to exemplary embodiments, wherein the instructions, when executed, may further cause the processor 104 to perform the following: transmitting another electronic notification to the card user computing device that a fraudulent transaction is detected; and receiving input data from the card user computing device confirming that the transaction is fraudulent.

According to exemplary embodiments, wherein the instructions, when executed, may further cause the processor 104 to perform the following: transmitting another electronic notification to the card user computing device that a fraudulent transaction is detected; and receiving input data from the card user computing device confirming that the transaction is not fraudulent.

According to exemplary embodiments, wherein the instructions, when executed, may further cause the processor 104 to perform the following: triggering a digital channel that leverages an existing application programming interface (API) to validate whether the card users are still eligible for the credit limit increase or not; and transmitting the electronic notification to the card user computing device in real time based on the validation.

Thus, the exemplary embodiments disclosed herein with reference to FIGS. 1-16 may provide platforms for implementing a credit limit increase module that sends a notification in real time to a client computing device as soon as a threshold credit limit is detected based received transaction data along with a link to a digital channel where the client can opt in for increase in credit limit, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for implementing a credit limit increase module by utilizing one or more processors and one or more memories, the method comprising:
causing a risk team computing device to access a database for receiving historical data associated with card user information;
applying rules on the historical data;
electronically generating a file that includes data corresponding to card users who are eligible for a credit limit increase based on the applied rules on the historical data;
transmitting the file to a card servicing computing device;
causing the card servicing computing device to validate that the card users are still eligible for the credit limit increase and maintain the file on the database based on validation;
causing the card servicing computing device to receive transaction data originated at a point of sale terminal device when the card user initiates a card transaction;
accessing the file from the database in real time to check whether the card user is among the card users who are eligible for a credit limit increase based on the received transaction data;
determining whether the transaction data is equal to or above a predetermined threshold data; and
transmitting an electronic notification to a card user computing device in real time to notify that the card user is eligible for the credit limit increase based on a positive determination that the transaction data is equal to or above a predetermined threshold data.

2. The method according to claim 1, wherein transmitting the electronic notification includes transmitting the electronic notification to the card user computing device in real time in accordance with any one of the group consisting of SMS (Short Message Service), IM (Instant Message), and e-mail.

3. The method according to claim 2, further comprising:
receiving input data from the card user computing device to accept the credit limit increase; and
automatically approving the credit limit increase in real time based on the received input data.

4. The method according to claim 2, further comprising:
receiving input data from the card user computing device to reject the credit limit increase;
modifying the threshold value data by the risk team computing device; and
storing, onto the database, the modified threshold value data corresponding to the card user for future decision on approving the credit limit increase.

5. The method according to claim 1, further comprising:
attaching a uniform resource locator (URL) link with the electronic notification;
receiving user's consent data on increasing the credit limit based on clicking of the URL link; and
automatically approving the credit limit increase in real time based on the received consent data.

6. The method according to claim 1, further comprising:
generating historical aggregate data based on prior transaction activities of the card user from a plurality of databases for transactions;
integrating the transaction data with the historical aggregate data;
executing a machine learning module using the integrated transaction data and the historical aggregate data to generate a fraud score; and
determining whether the transaction data is fraudulent based on the generated fraud score.

7. The method according to claim 6, further comprising:
authorizing the transaction data based on a positive determination that the fraud score is a value that is at or above a predetermined fraud threshold value; and
simultaneously transmitting the electronic notification to the card user computing device in real time to notify that the card user is eligible for the credit limit increase based on the positive determination that the fraud score is a value that is at or above a predetermined fraud threshold value.

8. The method according to claim 6, further comprising:
denying the transaction data based on a negative determination that the fraud score is a value that is below a predetermined threshold; and
simultaneously blocking transmission of the electronic notification to the card user computing device based on the negative determination that the fraud score is a value that is below a predetermined fraud threshold value.

9. The method according to claim 8, further comprising:
transmitting another electronic notification to the card user computing device that a fraudulent transaction is detected; and
receiving input data from the card user computing device confirming that the transaction is fraudulent.

10. The method according to claim 8, further comprising:
transmitting another electronic notification to the card user computing device that a fraudulent transaction is detected; and
receiving input data from the card user computing device confirming that the transaction is not fraudulent.

11. The method according to claim 1, further comprising:
triggering a digital channel that leverages an existing application programming interface (API) to validate whether the card users are still eligible for the credit limit increase or not; and
transmitting the electronic notification to the card user computing device in real time based on the validation.

12. A system for implementing a real time credit limit increase process, the system comprising:
a database including memories that store historical data associated with card user information processor; and
a processor operatively connected to the database via a communication link, wherein the processor is configured to:
cause a risk team computing device to access the database for receiving the historical data associated with card user information;
apply rules on the historical data;
electronically generate a file that includes data corresponding to card users who are eligible for a credit limit increase based on the applied rules on the historical data;
transmit the file to a card servicing computing device;
cause the card servicing computing device to validate that the card users are still eligible for the credit limit increase and maintain the file on the database based on validation;
cause the card servicing computing device to receive transaction data originated at a point of sale terminal device when the card user initiates a card transaction;
access the file from the database in real time to check whether the card user is among the card users who are eligible for a credit limit increase based on the received transaction data;
determine whether the transaction data is equal to or above a predetermined threshold data; and
transmit an electronic notification to a card user computing device in real time to notify that the card user is eligible for the credit limit increase based on a positive determination that the transaction data is equal to or above a predetermined threshold data.

13. The system according to claim 12, wherein, in transmitting the electronic notification, the processor is further configured to: transmit the electronic notification to the card user computing device in real time in accordance with any one of the group consisting of SMS (Short Message Service), IM (Instant Message), and e-mail.

14. The system according to claim 13, wherein the processor is further configured to:
receive input data from the card user computing device to accept the credit limit increase; and
automatically approve the credit limit increase in real time based on the received input data.

15. The system according to claim 13, wherein the processor is further configured to:
receive input data from the card user computing device to reject the credit limit increase;
modify the threshold value data by the risk team computing device; and
store, onto the database, the modified threshold value data corresponding to the card user for future decision on approving the credit limit increase.

16. The system according to claim 12, wherein the processor is further configured to:
attach a uniform resource locator (URL) link with the electronic notification;
receive user's consent data on increasing the credit limit based on clicking of the URL link; and
automatically approve the credit limit increase in real time based on the received consent data.

17. The system according to claim 12, wherein the processor is further configured to:
generate historical aggregate data based on prior transaction activities of the card user from a plurality of databases for transactions;
integrate the transaction data with the historical aggregate data;
execute a machine learning module using the integrated transaction data and the historical aggregate data to generate a fraud score; and
determine whether the transaction data is fraudulent based on the generated fraud score.

18. The system according to claim 17, wherein the processor is further configured to:
authorize the transaction data based on a positive determination that the fraud score is a value that is at or above a predetermined fraud threshold value; and
simultaneously transmit the electronic notification to the card user computing device in real time to notify that the card user is eligible for the credit limit increase based on the positive determination that the fraud score is a value that is at or above a predetermined fraud threshold value.

19. The system according to claim 17, wherein the processor is further configured to:
deny the transaction data based on a negative determination that the fraud score is a value that is below a predetermined threshold; and
simultaneously block transmission of the electronic notification to the card user computing device based on the negative determination that the fraud score is a value that is below a predetermined fraud threshold value.

20. The system according to claim 19, wherein the processor is further configured to:
transmit another electronic notification to the card user computing device that a fraudulent transaction is detected; and
receive input data from the card user computing device confirming that the transaction is fraudulent.

21. The system according to claim 19, wherein the processor is further configured to:
transmit another electronic notification to the card user computing device that a fraudulent transaction is detected; and
receive input data from the card user computing device confirming that the transaction is not fraudulent.

22. The system according to claim 12, wherein the processor is further configured to:
trigger a digital channel that leverages an existing application programming interface (API) to validate whether the card users are still eligible for the credit limit increase or not; and
transmit the electronic notification to the card user computing device in real time based on the validation.

23. A non-transitory computer readable medium configured to store instructions for implementing a real time credit limit increase process, wherein, when executed, the instructions cause a processor to perform the following:
causing a risk team computing device to access a database for receiving historical data associated with card user information;
applying rules on the historical data;
electronically generating a file that includes data corresponding to card users who are eligible for a credit limit increase based on the applied rules on the historical data;
transmitting the file to a card servicing computing device;
causing the card servicing computing device to validate that the card users are still eligible for the credit limit increase and maintain the file on the database based on validation;
causing the card servicing computing device to receive transaction data originated at a point of sale terminal device when the card user initiates a card transaction;
accessing the file from the database in real time to check whether the card user is among the card users who are eligible for a credit limit increase based on the received transaction data;
determining whether the transaction data is equal to or above a predetermined threshold data; and
transmitting an electronic notification to a card user computing device in real time to notify that the card user is eligible for the credit limit increase based on a positive determination that the transaction data is equal to or above a predetermined threshold data.
